(19) United States
(12) Patent Application Publication
(10) Pub. No.: US 2011/0154232 A1
(43) Pub. Date: Jun. 23, 2011

(54) SYSTEMS, METHODS, AND COMPUTER PROGRAM PRODUCTS FOR MANAGING OBJECT ALERTS

(76) Inventors: Charles Griep, St. Anthony, MN (US); Brian Wegleitner, Andover, MN (US)

(21) Appl. No.: 12/644,517

(22) Filed: Dec. 22, 2009

(51) Int. Cl. G06F 9/44; G06F 3/048; G06F 15/173

(52) U.S. Cl. 715/764; 717/120; 709/224

(57) ABSTRACT

A method for providing information regarding a monitored distributed computer system includes applying an object filter to a plurality of monitored objects, the object filter specifying an object state that is more complex than a single property value, and raising an alert upon at least one of the monitored objects satisfying the object state.

### RELATED APPLICATIONS

The following commonly-assigned patent applications have at least some subject matter in common with the current application:

Ser. No. 12/568,963 entitled “Method and Apparatus for User-Defined Managed Objects”, filed Sep. 29, 2009 attorney docket number RA5890;

Ser. No. 12/568,704 entitled “Method and Apparatus for Reporting an Alert State at Any Level of a Hierarchy of Objects”, filed Sep. 29, 2009, attorney docket number RA5891;

Ser. No. 12/568,991 entitled “Method and Apparatus for Unrestricted Reporting of Alert States for Managed Objects, Regardless of Type”, filed Sep. 29, 2009, attorney docket number RA5892;

Ser. No. 12/568,705 entitled “Method and Apparatus for Displaying Multiple States Within a Single Image”, filed Sep. 29, 2009, attorney docket number RA5894;

Ser. No. 12/568,706 entitled “Method and Apparatus for Displaying a Monitored State With No Explicit Connection”, filed Sep. 29, 2009, attorney docket number RA5895.

### TECHNICAL FIELD

The present disclosure relates to managing classes in object-oriented programming. In particular, the present disclosure relates to managing objects in mainframes or large distributed computing systems.

### BACKGROUND

Information technology systems are essential to any modern business. These systems have grown more and more complex. Today they can include distributed centers located anywhere from a few miles apart to those across the continent or in separate countries. Today, personal computers are common and many businesses employ multiple operating systems from various vendors. Often systems are dispersed in branch offices running critical applications or containing essential data.

Tools are available that integrate operational control of multiple heterogeneous mainframes and distributed systems. These systems include numerous components that need to be managed. Typically, managed objects are used to view, monitor, and manage these components. The managed objects are typically predefined in operational software for managing the components of the system. Conventional systems employ filters that compare managed objects to a single-property threshold, whereby an alert is raised on a managed object when a single property of the object satisfies the single-property threshold. Furthermore, some conventional systems are operable to map multiple, single-threshold alerts to a single alert by triggering the single alert off of the occurrence of the other alerts. However, such conventional systems are not operable to provide alerts based on object states that are not represented by a single property of an object (e.g., an object state that is defined by two or more properties collectively).

For these and other reasons, improvements are desirable.

### SUMMARY

In accordance with the following disclosure, the above and other problems are solved by the following:

According to a first embodiment, a computer program product, having a computer readable medium having computer program logic recorded thereon for providing information regarding conditions of a distributed computer system, includes code for applying a filter to at least one object. The filter includes a set of object conditions that when satisfied give rise to an alert, the set of object conditions being more complex than a single property value. The computer program product also includes code for generating the alert when the set of object conditions of the filter are satisfied.

According to another embodiment, a system for providing information regarding conditions of a distributed computer platform includes a first functional unit that receives input specifying an object state. The object state is more complex than a single property value. Furthermore, a second functional unit applies an object filter based upon the input specifying the object state, and a third functional unit that raises an alert on a monitoring system when the filter discerns that the object state is satisfied by a monitored object.

In yet another embodiment, a monitoring system for providing information regarding conditions of a distributed computer system includes means for applying a filter to at least one object, in which the filter includes a set of conditions that when satisfied give rise to an alert. The set of conditions are more complex than a single property value. The monitoring system also includes means for generating the alert when the set of conditions of the filter are satisfied.

Additionally, a method for providing information regarding a monitored distributed computer system includes applying an object filter to a plurality of monitored objects. The object filter specifies an object state that is more complex than a single property value. The method also includes raising an alert upon at least one of the monitored objects satisfying the object state.

### BRIEF DESCRIPTION OF THE DRAWINGS

FIG. 1 is a block diagram of an operational system for managing a large computing distributed computing system adapted according to one example embodiment;

FIG. 2 is an illustration of an exemplary operational flow for managing objects, e.g., in the system of FIG. 1, adapted according to one example embodiment;

FIG. 3 is a screenshot of an exemplary Graphical User Interface (GUI) adapted according to one example embodiment; and

FIG. 4 is an operational flow diagram illustrating a method of monitoring objects adapted according to one example embodiment.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The logical operations of the various embodiments of the disclosure described herein are implemented as: (1) a sequence of computer implemented steps, operations, or procedures running on a programmable circuit within a computer, and/or (2) a sequence of computer implemented steps, operations, or procedures running on a programmable circuit within a directory system, database, or compiler.

Object-oriented programming uses primarily classes and objects. A class creates a new type where objects are instances of the class. Objects can store data using ordinary variables that belong to the object. Variables that belong to an object or class are called fields. Objects can also have functionality by using functions that belong to a class. Such functions are called methods of the class. Collectively, the fields and methods can be referred to as the attributes of that class. Fields can belong to each object of the class or they can belong to the class itself.

Classes are created in the source code itself by using the class statement followed by the name of the class. An object of the class can then be created. Class variables are shared by all objects of that class. There is only one copy of the class variable, and when an object makes a change to a class variable, the change is reflected in all other objects as well. Object variables are owned by each object and are not shared. Subclasses can also be used that inherit the properties of the parent class, but can also have additional defined properties. Instance is the name of a single managed object associated with an actual system on the network.

In general, the present disclosure relates to the capability for users to manage systems and components of computing systems such as disks, tapes, users, and processes by managing classes within an operational system. One class may relate to disk drives in the computing system, while one object relates to a particular disk drive. Many classes are typically predefined in the operational system. The present disclosure relates to generating alerts based on object states. An example alert might be that a disk drive, an object of the managed system, is close to full. An alert can be sent via an alert event report that requires the recipient of the report to be identified in Class and Instance properties of the event report.

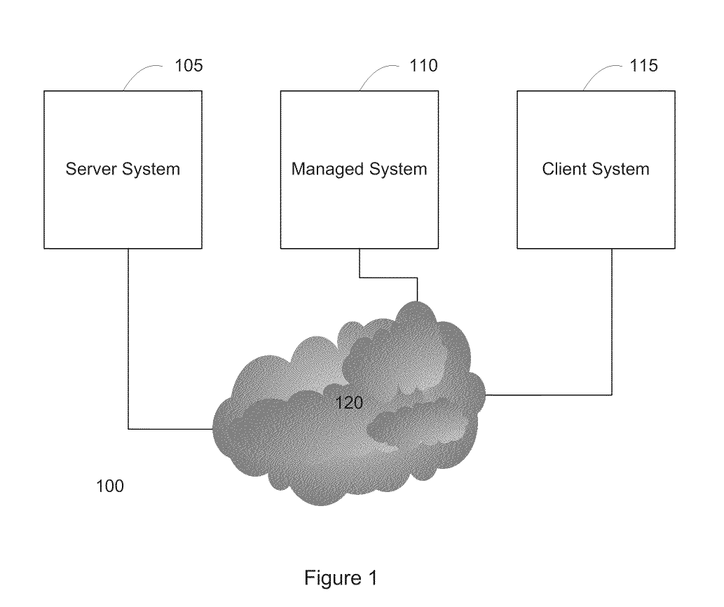

In one example embodiment, Operations Sentinel® by Unisys® provides an operational environment for managing large computing systems, such as the computing system 100 of FIG. 1. Operations Sentinel® can include a Graphical User Interface (GUI) for managing alerts in the computing system in which at least some of the alerts are based on object states.

Various embodiments allow the user to set a filter that raises an alert when a managed object is in a specified state in which the specified state is not represented by a single property. Such embodiments may also allow for creation of thresholds that span object types or entire object configurations. A single filter can be used to check objects of all types for similar states of alert.

In this example, users create thresholds that are independent of object types using object filters. The object filters specify values and/or ranges for selected properties of various object types. For a given filter, its specified values and/or ranges identify a significant state for a managed object, and such significant state may give rise to an alert. Users can set the filters by specifying one or more alerts to raise when an object matches an identified state.

Once the object filters are saved, the thresholding services of a monitoring system monitor objects by checking the objects against each object filter, e.g., when the objects are updated or modified. Such monitoring can be continuous during operation of the monitoring system. If a given object matches an object state specified by an object filter, then the associated alert is raised according to the user settings. If the conditions of an object filter are not satisfied then an alert is not raised or, if previously raised, the alert is cleared. Thus, if an object is changed so that it no longer matches the conditions of a given object filter, then an existing alert associated with the given object filter is cleared.

FIG. 1 is a block diagram of an operational system for managing a large distributed computing system 100 adapted according to one example embodiment. Preferably, the system 100 includes a server system 105, a managed system 110, and a client system 115, as is well known in the art. The server system 105, managed system 110, and the client system 115 preferably communicate with one another over a network 120, which can be any suitable network such as a LAN, WAN, or any other network.

In one possible embodiment, the server system 105 acts as a maintenance processing system and/or a utility monitoring processing system that functions to monitor the activities and health of the components, processes, and tasks executing within the managed system 110. The managed system 110 performs the processing desired by the operators of the managed system 110. Client systems, such as system 115, are processing systems utilized by operators of the managed system 110 to view operations, maintenance and health information regarding the components, processes and tasks in the managed system 110.

In the embodiment shown in FIG. 1, these three systems are shown to be separate processing systems. One of ordinary skill in the art will recognize that these systems may be implemented to operate on one as well as numerous hardware systems without deviating from the spirit and scope of the present invention as recited within the attached claims.

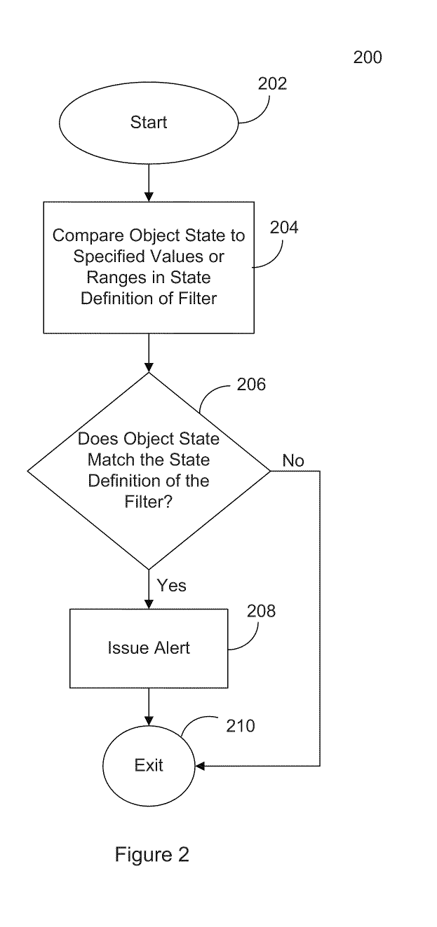

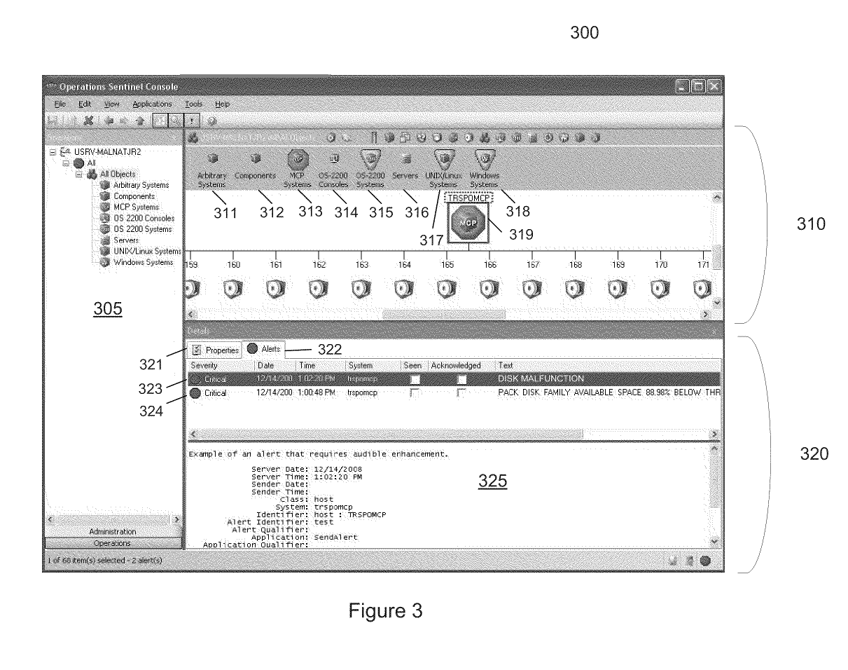

In various embodiments, the server system 105 runs a monitoring program that monitors the operation of the managed system 110 and provides alerts based on object states, as described in more detail below with respect to FIGS. 2-4. In one example embodiment, Operations Sentinel® by Unisys® provides an operational environment for managing large computing systems. Operations Sentinel® includes predefined classes for managing objects in the computing system. Such classes can include an Arbitrary system, MCP system, OS 2200 Console, OS 2200 System, Server, UNIX/Linux System, Windows System and Component. A user can manage objects using Operations Sentinel® by interacting with an interface (e.g., the GUI 300 of FIG. 3) that provides the user with options to acknowledge and/or clear various alerts.

FIG. 2 is an illustration of an exemplary operational flow 200 for managing objects, e.g., in the system of FIG. 1, adapted according to one embodiment. Specifically, in some embodiments, the server system 105 runs a program that performs the various actions described below.

The operational flow 200 begins at block 202. A compare module 204 compares the state of an object to the specified values and/or ranges in the state definition of the object filter. For instance, a given object filter may specify a state by defining values and/or ranges for multiple properties. Some filters may span multiple object types or object configurations by defining values and/or ranges of properties that are associated with multiple object types. Furthermore, in some embodiments, the filters themselves are objects with their own fields and properties.

In one example, an OS 2200 System object has separate properties (each allowing a threshold to be defined) for the number of currently active batch and demand runs. To monitor the load on the system, a multiple-property threshold is set for these two properties. The compare module 204 compares the state of the OS 2200 System object to the multiple-property threshold.

A match operation 206 determines if the object state matches the state definition of the object filter. If the match operation 206 determines that there is no match, the process exits at 210. If the match operation 206 determines that there is a match, an alert module 206 issues an alert, and the process exits at block 210.

Returning to the example of the OS 2200 System object, there is a match when the combination of the values of the two properties exceeds the set multiple-property threshold. If the object is then changed, e.g., by intervention of a user to change the object, such that the match no longer exists, then the alert is cleared.

While the operational flow 200 is shown as a series of discrete actions, the scope of embodiments is not so limited. Various embodiments may add, omit, rearrange, or modify actions with respect to the operational flow 200. For instance, some embodiments include receiving input from the user specifying conditions for an object filter, saving, and executing the filter. Additionally, some embodiments include applying multiple object filters to multiple objects so that the operational flow 200 can be scaled to conform to a size of a given monitored system. It should be noted that various systems may perform the operational flow 200 continuously, periodically, and/or upon occurrence of certain evens such as when an object is created or updated.

FIG. 3 is a screenshot of an exemplary GUI 300 adapted according to one example embodiment. The GUI 300 can be used by a human operator to manage objects and alerts. Preferably, the GUI 300 has a navigation pane 305 to the left, illustrating a hierarchy of views and sub-views. A top view pane 310 includes icons 311-318, each of which represents a managed object associated with a component of a managed system. Item 319 includes a graphic representation of an alert, and the alert is described in more detail below.

Preferably, a detail pane 320 includes a Properties tab 321 and an Alert tab 322. The Properties tab 321, when selected, shows the properties of a given object. As illustrated in FIG. 3, the Alert tab 322 is selected, and the detail pane 320 lists the alerts for the MCP Systems (represented by icon 313 in the top view pane 310). Alert conditions are raised when an alert event is received by the operations system. There are many sources for alerts, ranging from conditions raised by the user to conditions that are automatically detected by the operations system, such as alerts issued by the object filters described above. Furthermore, a human operator can use the GUI to clear alerts when they arise.

The detail pane 320, in this example, shows a first alert 323 and a second alert 324. The second alert 324 is selected. The selection of the first alert 323 causes the description portion 325 of the detail pane 320 to show details about the first alert 323. According to the information in the description portion 325, the first alert 323 is associated with a system “trspomcp,” which is an instance of the “host” class.

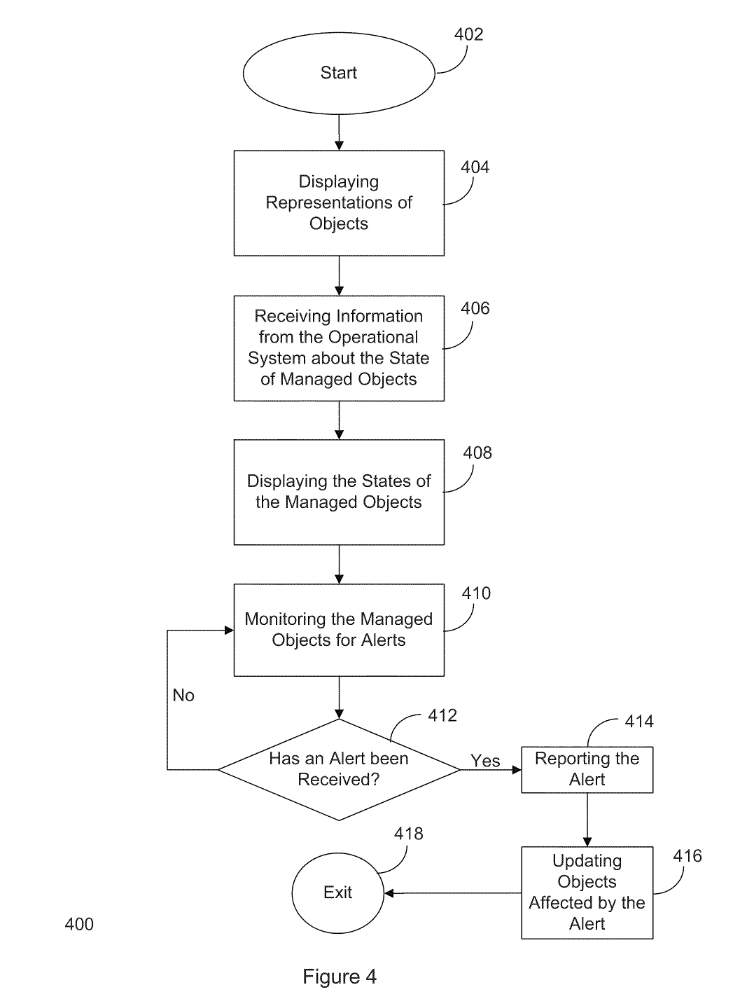

FIG. 4 is a diagram illustrating an operational flow 400 for monitoring objects according to one embodiment. The operational flow 400 may be performed, e.g., a monitoring system such as the server 105 of FIG. 1. The operational flow begins at a start point 402. A first display operation 404 displays the objects for the user. For example, the display operation 404 may display the objects in a window such as the GUI 300 of FIG. 3.

A first retrieve operation 406 retrieves information from the operational system about the states of the managed objects. In some instances, a state of an object may give rise to an alert, according to one or more object filters, as described above. A second display operation 408 displays the states of the managed objects. For example, a particular managed object might have a major alert associated therewith. In such scenario, the second display operation 408 displays that the particular managed object has an alert. For example, the second display operation 408 may display one or more alerts as illustrated in GUI 300 of FIG. 3.

A monitor operation 410 monitors the managed objects in the operational system for an alert. A determine operation 412 determines if an alert has been received. If the determine operation 412 determines that an alert has not been received, then operational flow branches “NO” back to the monitor operation 410. If the determine operation 412 determines that an alert has been received, operational flow branches “YES” to a report operation 414. The report operation 414 reports the alert. For example, the report operation 414 might report the alerts to the retrieving operation 406 so that the alerts are shown as in FIG. 3 and discussed above. An update operation 416 updates any managed object for which the alert is raised. In other words, the update operation 416 would cause the visual representation of any managed object or view to change to reflect is current condition.

Operational flow exits at end point 418. It is noted though that for repeated monitoring, the operational flow 400 would not end at exit point 418, but would loop back to the monitor operation 410.

Various embodiments may include one or more advantages over conventional systems. In the past, single-property thresholds existed whereby an alert was raised on a managed object when a single property of the object satisfied a user-supplied condition. In such conventional systems, multiple alerts (not properties) may be mapped into a single alert. However, in a scenario wherein a user desires to create a single alert when conditions A and B are both satisfied, the user of a conventional system has no other alternative but to cause an alert when A is satisfied, when B is satisfied, and when A and B are both satisfied, for a total of at least three alerts. By contrast, various embodiments of the disclosure expand the threshold alerting mechanism to allow for object state thresholds, in addition to the existing single-property state thresholds, such that an alert is raised on a managed object when it satisfies a filter that defines a set of conditions. Thus, various embodiments allow multiple property conditions to be linked together in a filter that when matched by an object will raise an alert on the object.

It is recognized that the above systems and methods operate using computer hardware and software in any of a variety of configurations. Such configurations can include computing devices, which generally include a processing device, one or more computer readable media, and a communication device. Other embodiments of a computing device are possible as well. For example, a computing device can include a user interface, an operating system, and one or more software applications. Several example computing devices include a personal computer (PC), a laptop computer, or a personal digital assistant (PDA). A computing device can also include one or more servers, one or more mass storage databases, and/or other resources.

A processing device is a device that processes a set of instructions. Several examples of a processing device include a microprocessor, a central processing unit, a microcontroller, a field programmable gate array, and others. Further, processing devices may be of any general variety such as reduced instruction set computing devices, complex instruction set computing devices, or specially designed processing devices such as an application-specific integrated circuit device. Computer readable media includes volatile memory and non-volatile memory and can be implemented in any method or technology for the storage of information such as computer readable instructions, data structures, program modules, or other data. In certain embodiments, computer readable media is integrated as part of the processing device. In other embodiments, computer readable media is separate from or in addition to that of the processing device. Further, in general, computer readable media can be removable or non-removable. Several examples of computer readable media include, RAM, ROM, EEPROM and other flash memory technologies, CD-ROM, digital versatile disks (DVD) or other optical storage, magnetic cassettes, magnetic tape, magnetic disk storage or other magnetic storage devices, or any other medium that can be used to store desired information and that can be accessed by a computing device. In other embodiments, computer readable media can be configured as a mass storage database that can be used to store a structured collection of data accessible by a computing device.

A communications device establishes a data connection that allows a computing device to communicate with one or more other computing devices via any number of standard or specialized communication interfaces such as, for example, a universal serial bus (USB), 802.11a/b/g network, radio frequency, infrared, serial, or any other data connection. In general, the communication between one or more computing devices configured with one or more communication devices is accomplished via a network such as any of a number of wireless or hardwired WAN, LAN, SAN, Internet, or other packet-based or port-based communication networks.

The above specification, examples and data provide a complete description of the manufacture and use of the composition of the invention. Since many embodiments of the invention can be made without departing from the spirit and scope of the invention, the invention resides in the claims hereinafter appended.

1. A computer program product having a computer readable medium having computer program logic recorded thereon for providing information regarding conditions of a distributed computer system, the computer program product comprising:
code for applying a filter to at least one object, in which the filter includes a set of object conditions that when satisfied give rise to an alert, the set of object conditions being more complex than a single property value; and
code for generating the alert when the set of object conditions of the filter are satisfied.

2. The computer program product of claim 1 further comprising code for clearing the alert upon modification of the at least one object.

3. The computer program product of claim 3 further comprising:
code for displaying the alert on a Graphical User Interface (GUI).

4. The computer program product of claim 1 in which the set of object conditions comprises a plurality of items selected from the list consisting of:
a property value; and
a property value range.

5. The computer program product of claim 1 further comprising:
code for receiving input indicating the set of object conditions; and
code for generating the filter based upon said input.

6. The computer program product of claim 1 further comprises:
code for interacting with a human operator to clear the alert.

7. A system for providing information regarding conditions of a distributed computer platform, the system comprising:
a first functional unit that receives input specifying an object state, the object state being more complex than a single property value;
a second functional unit that applies an object filter based upon the input specifying the object state;
a third functional unit that raises an alert on a monitoring system when the filter discerns that the object state is satisfied by a monitored object.

8. The system of claim 7 in which the monitoring system comprises the first, second, and third functional units.

9. The system of claim 7 in which the monitoring system comprises a server in communication with a monitored system that includes the monitored object.

10. The system of claim 7 further comprising:
a Graphical User Interface (GUI) rendering the alert.

11. The system of claim 7 in which the object state comprises a plurality of property values.

12. The system of claim 7 in which the object state comprises at least one property value range.

13. The system of claim 7 further comprising a fourth functional unit that clears the alert upon modification of the monitored object.

14. A monitoring system for providing information regarding conditions of a distributed computer system, the monitoring system comprising:
means for applying a filter to at least one object, in which the filter includes a set of conditions that when satisfied give rise to an alert, the set of conditions being more complex than a single property value; and
means for generating the alert when the set of conditions of the filter are satisfied.

15. The monitoring system of claim 1 further comprising means for clearing the alert upon modification of the at least one object.

16. The monitoring system of claim 15 in which the alert generating means comprise:
means for displaying the alert on a Graphical User Interface (GUI).

17. The monitoring system of claim 14 in which the set of conditions comprises a plurality of items selected from the list consisting of:
a property value; and
a property value range.

18. The monitoring system of claim 14 in which the filter applying means comprise:
means for generating the filter based upon input indicating the set of conditions.

19. The monitoring system of claim 14 in which the alert generating means comprise:
means for interacting with a human operator to clear the alert.

20. A method for providing information regarding a monitored distributed computer system, the method comprising:
applying an object filter to a plurality of monitored objects, the object filter specifying an object state that is more complex than a single property value; and
raising an alert upon at least one of the monitored objects satisfying the object state.

21. The method of claim 20 in which the monitored objects include a plurality of object types.

22. The method of claim 20 further comprising:
receiving input generating the object filter.

23. The method of claim 20 in which the alert is raised on a Graphical User Interface (GUI) on a computer system.
